(19) United States
(12) Patent Application Publication
(10) Pub. No.: US 2013/0219459 A1
(43) Pub. Date: Aug. 22, 2013

(54) CONTENT MANAGEMENT SYSTEMS AND METHODS

(71) Applicant: INTERTRUST TECHNOLOGIES CORPORATION, (US)

(72) Inventor: William B. Bradley, Oakland, CA (US)

(73) Assignee: INTERTRUST TECHNOLOGIES CORPORATION, Sunnyvale, CA (US)

(21) Appl. No.: 13/773,433

(22) Filed: Feb. 21, 2013

Related U.S. Application Data
(60) Provisional application No. 61/601,524, filed on Feb. 21, 2012.

(51) Int. Cl. H04L 29/06

(52) U.S. Cl. CPC H04L 63/08
USPC 726/1

(57) ABSTRACT

This disclosure relates to systems and methods for managing content. In one embodiment, a method of managing electronic content from a plurality of a user's computing devices is disclosed. Content from the devices is automatically uploaded to a media hub service that securely routes, processes, synchronizes, and/or stores the content in accordance one or more user-specified policies.

### RELATED APPLICATION

This application claims the benefit of priority under 35 U.S.C. 119 (e) to U.S. Provisional Patent Application No. 61/601,524, filed Feb. 21, 2012, and entitled “CONTENT MANAGEMENT SYSTEMS AND METHODS,” which is hereby incorporated by reference in its entirety.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY

The present disclosure relates generally to systems and methods for facilitating the management and control of electronic content. Tools and devices that enable people to create high quality digital images, videos, and audio have vastly improved. Along with these tools for creating content have also come services for sharing it with friends, family, acquaintances, and the world. Indeed, as these tools and services improve, users are increasingly finding that there is a market for some of their “user-generated” content. Various models and services for distributing it for a fee as well as for free—possibly together with advertisements—are evolving. FIG. 1 depicts the current situation. As shown in FIG. 1, a variety of user devices 102a-102h may send content to and/or receive content from each other, and/or to or from one or more network locations or services 104a-e, such as a photo-sharing service 104a, a network archive server 104b, an Internet video-sharing service 104c, a social networking website 104d, a home network server 104e, and/or the like. For example, a user may transfer one or more digital pictures from camera 102g to the user's personal computer 102d, and then upload some of those pictures to social networking website 104d.

As it becomes easier for consumers to produce new digital content, especially photos, movies, and audio recordings on digital cameras and phones, managing that content becomes more difficult. The following problems are typical:
Photos and videos accumulate on phones, cameras, memory cards, disks, and PC hard drives. The typical consumer does not effectively manage this storage and/or does not know how.
While some people have learned to use many of the consumer content hosting services for their content, even sharing their content on social networks, it is still very difficult for the average consumer to manage and network all of their content, making it available when and where they want to enjoy and share it.
It is difficult for consumers to deal with device and computer networks, including the various connection types: USB, Wifi, Bluetooth, Ethernet, Firewire, HDMI, etc. and the various mechanisms used to connect and protect devices on these networks, such as routers, firewalls, gateways, etc. Network management can be hard and tedious.
Once content does become available on a network (public or private), it is very difficult to persistently protect it from open public access and unintended use.
Once content is safely stored, it can be difficult to find what you want and then make it available when and where you want it, using the device you favor.

What is needed are systems and methods for enabling people to spend less time storing, transferring, finding, relaying, transforming, archiving, sorting, searching, protecting, synchronizing, classifying, and/or managing their content and to spend more time enjoying and sharing it. Systems and methods that address some or all of these needs are described herein.

### BRIEF DESCRIPTION OF THE DRAWINGS

The inventive body of work will be readily understood by referring to the following detailed description in conjunction with the accompanying drawings, in which:

FIG. 1 illustrates exemplary device and network sharing relationships consistent with embodiments of the present disclosure.

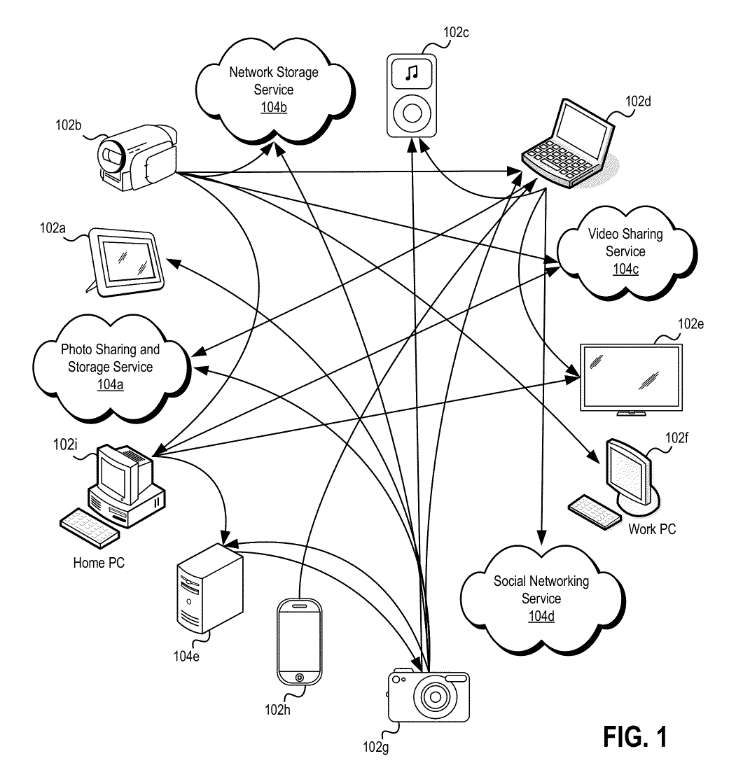

FIG. 2A depicts some illustrative usage scenarios, relationships, and features enabled by some embodiments of the systems and methods described herein.

FIG. 2B is an example of how a system in accordance with embodiments of the inventive body of work could be used to facilitate the secure, automated management of content.

FIG. 2C is an additional example of how a system in accordance with embodiments of the inventive body of work could be used to facilitate the secure, automated management of content.

FIG. 2D is an additional example of how a system in accordance with embodiments of the inventive body of work could be used to facilitate the secure, automated management of content.

FIG. 2E is an additional example of how a system in accordance with embodiments of the inventive body of work could be used to facilitate the management of content.

FIG. 3 depicts some functional elements and relationships in one illustrative embodiment of a media management service.

FIG. 4 illustrates an interface for facilitating the creation of content groups in one embodiment.

FIG. 5 shows another illustrative interface for use with a service in accordance with some embodiments of the present disclosure.

FIG. 6 shows an example of how a service in accordance with some embodiments of the present disclosure could be integrated with another service.

FIG. 7 shows an illustrative process for selecting a photo and importing it to another service.

FIG. 8 shows an example interface for obtaining content in accordance with one example embodiment.

FIG. 9 shows an example of watermarked content in accordance with one example embodiment.

FIG. 10 shows an example of a content processing rule in accordance with one embodiment.

FIG. 11 shows another example of a content processing rule in accordance with one embodiment.

FIG. 12 illustrates an exemplary system that may be used to implement embodiments of the systems and methods disclosed herein.

### DETAILED DESCRIPTION

A detailed description of systems and methods consistent with the inventive body of work is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Many of the problems with content management (such as those listed above) are related to automation and control. Users struggle with elements of typical network configurations as they seek to synchronize their content across their different devices and service accounts. Users have begun to lose track and control of where their content is, who has access to the content, and how those with such access actually use the content. Users also must deal with the general problem of ensuring that their content is protected from hardware and software failures on the machines and servers that are used to store the content. These problems have given rise to a variety of content-type-specific services specialized to help users store, share, and even market their content. However, this proliferation of helper services, though useful for some purposes, also adds to the problems of control and organization.

Accordingly, in some embodiments, systems and methods described herein can be used to provide a central point of control—a hub—that people can use to automate the flow of their content through a network, and that people can use to access their content wherever they may be. People can use this interface to manage where their content is allowed to go, who is allowed access to it, and under what conditions. Additionally, this mechanism preferably supports commercial distribution models as well as access to users' content beyond the immediate control paradigms supported by the hub. Ultimately users may want to create content and have it automatically appear in the appropriate context—whether available to a community service, a specific group, a distribution process, or simply backed up—and they may want to maintain control over that process.

The following scenarios illustrate some of the ways in which such a “media hub” in accordance with the inventive body of work might be used.

A Hub for User Generated Content

Bob has created a large library of content that includes photographs, music, and videos. He has been using a variety of services to share his content with friends and others who may be interested in his work. He has accounts with popular photo-sharing and social network services, and multiple other services, and on each service he has uploaded sets of content to be accessed by different groups of friends and acquaintances. However he has found that it has become increasingly complicated to keep up with which services he has made specific content available to, and who has access to what.

Bob loads content to his local machines and his sharing service accounts in multiple ways, including direct upload from his wifi-enabled camera, his cell phone, his laptop, and a variety of other devices and/or services. For each upload, Bob must explicitly direct the content to the appropriate service or group of users with whom he wants to share. After uploading the content to any of his content sharing services, he has no convenient way of keeping up with his actions, and is concerned that he will continue to lose control of the location of his photos and of the uses to which they are being put.

Embodiments of the systems and methods described herein can help Bob by providing him with a central control point for all of the content that he generates, as well as a means to automate and catalog the flow of his content. In some embodiments, a central hub (or hubs) is provided to facilitate transparent communication among the various services and networks across which Bob makes his content available, and to allow him to readily access his content wherever it is located using any of his rendering devices. Additionally, in some embodiments, the hub enables Bob to create rules for specifying where his content should go, who should have access to it, and under what conditions. Bob finds that he can set the hub to recognize his wifi camera, receive pictures from it, and synchronize them with whatever services Bob specifies, or associate them with whatever groups he specifies. Bob finds further that he can provide an RSS feed for specified pieces of content and that advertising agencies might be willing to pay him to include their advertisements with content acquired via the RSS feed. Bob sees that he can have a centralized content management hub that provides him with a central content inventory and a central point of control for distribution and access.

Privacy Protection of Shared Content

The Smith family goes on vacation. Fred is the designated photographer and uses both a wifi-enabled still camera as well as a wifi-enabled camcorder. Fred captures everything and tells everyone in the family that the pictures and films will be available immediately on various social networking, photo-sharing, and video-sharing sites, but only accessible by members of his “family”—which includes everyone who attended the gathering.

Fred uses a media distribution service in accordance with embodiments of the inventive body of work described herein to manage his photos and movies, and to synchronize that content with the various external sites according to rules he specifies. The rules ensure that the content will only be available to members of his family, and, if he so specifies, even members of his family will not be able to share those images or movies with anyone outside of the group without his permission.

Protected Digital Distribution of High-Resolution Photos

Fiona is a photographer who uses popular photo sharing and other services to share and publicize her photographs. She would like to be able to make high-resolution digital versions of images available, but is concerned about completely losing control of the bits.

In accordance with embodiments of the systems and methods described herein, Fiona can control access to her photos with much finer granularity than that provided by her photo-sharing website memberships alone, while at the same time making use of the photo-sharing websites to continue to benefit from the feedback/community aspects.

Preferred embodiments of the systems and methods described herein can be used to provide a platform that fulfills the needs of consumers such as those described in the examples given above. Such a platform can provide users with means to manage their user-generated content (e.g., photos, videos, music, text, etc.). In accordance with some embodiments, an integrated content registry, content switch, and content hub can be provided, with which users can register their content, connect content sources with content destinations, and exercise centralized control. In some embodiments the platform may enable users to specify rules and policy that govern content and a mapping amongst content, devices, and collections of people, providing rules that govern content distribution, location and content access. Such a platform provides users with control over where content can go, who is allowed to see it, and/or under what circumstances. In one embodiment, users can set both the content movement rules as well as the content access rules. In some embodiments, digital rights management (“DRM”), security, and/or service orchestration technologies are used, such as those described in commonly assigned, co-pending U.S. patent application Ser. No. 11/583,693, filed Oct. 18, 2006, and published as Publ. No. 2007/0180519 A1 (“the '693 application”) and commonly assigned U.S. Pat. No. 8,234,387 (“the '387 patent”) (the contents of both the '693 application and the '387 patent are hereby incorporated by reference in their entirety herein).

Users can manage content distributed across a variety of services and networks; there need not be an assumption that there is a central content location. In preferred embodiments, the platform can recognize and authenticate users' content source devices as well as users' content access and rendering devices. The platform can synchronize users' content among their devices and their memberships in community-based services such as photo and/or video, sharing sites, social networking services, and the like. In some embodiments, support is provided for publishing content in a variety of ways, including, for example via RSS feeds or traditional download or streaming mechanisms. These models can be combined with a variety of e-commerce distribution paradigms based on traditional transaction mechanisms, advertisement-based mechanisms, and/or any other suitable distribution technique.

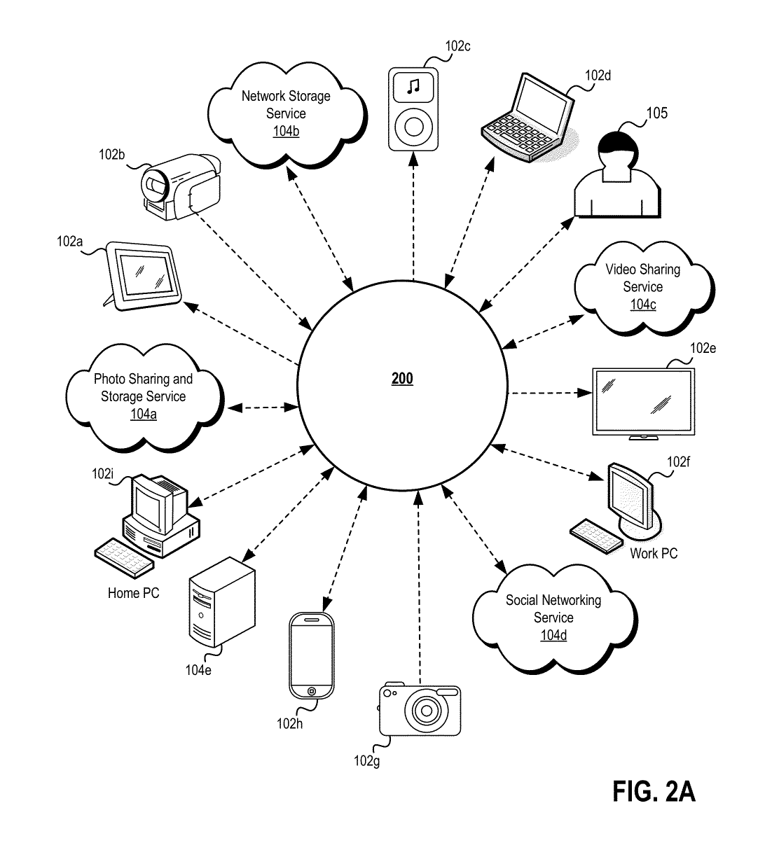

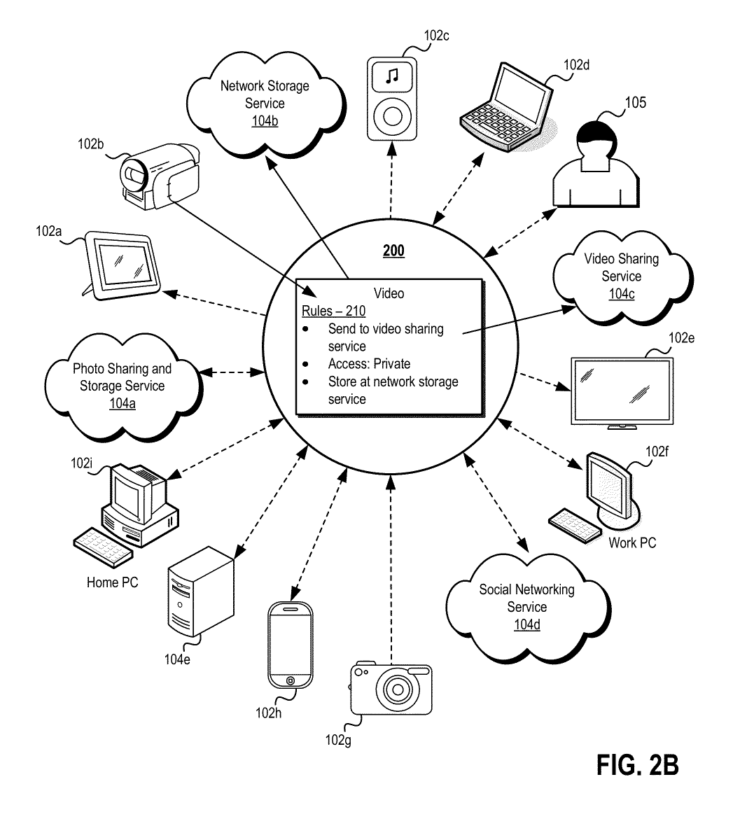

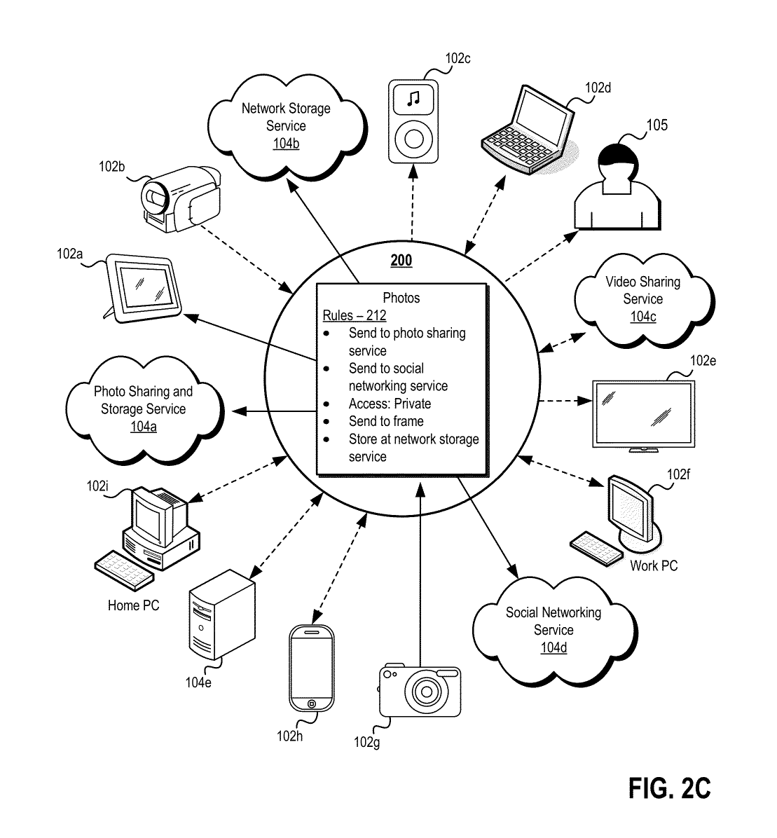

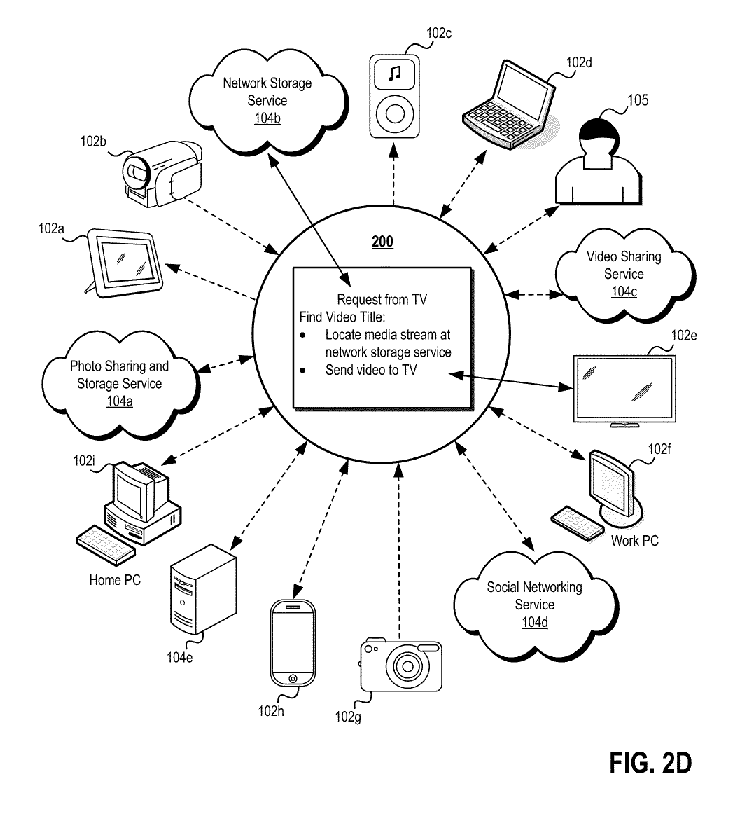

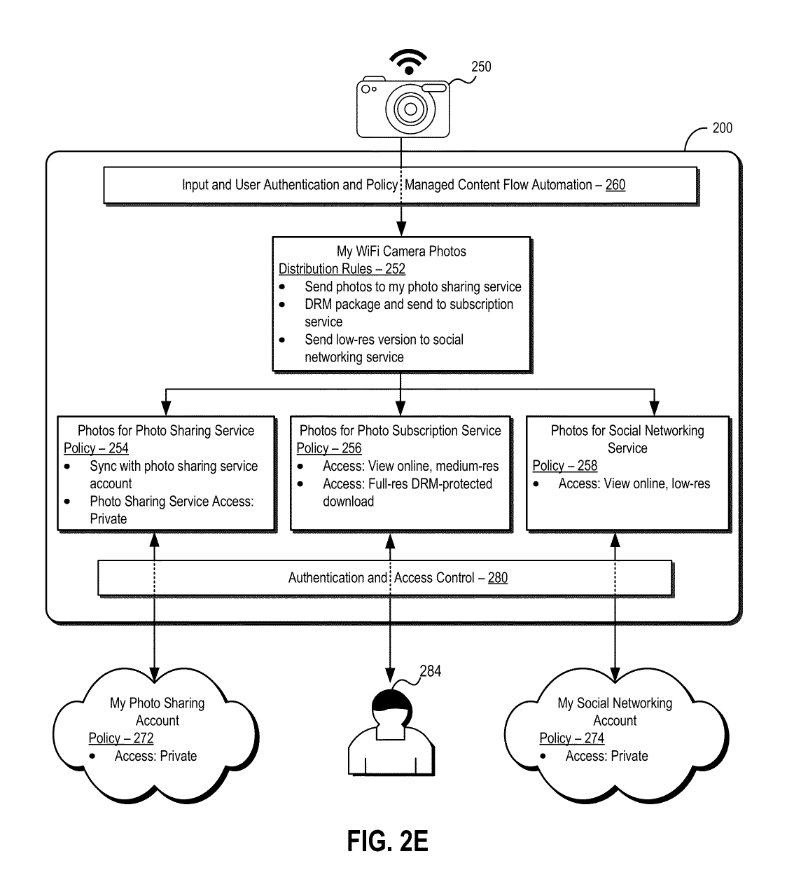

FIGS. 2A-2E depict some illustrative usage scenarios, relationships, and features enabled by some embodiments of the systems and methods described herein, and provide examples of how rules can be applied to govern the handling of different types of content. FIG. 2A illustrates how in some embodiments of the systems and methods described herein, devices 102, users 105, and/or services 104 can be authenticated before interacting with a content distribution and management service 200 in accordance with the inventive body of work. For example, a device 102 can be configured with a trusted credential or identifier (e.g., a digital certificate, serial number, machine signature, and/or the like) that automatically authenticates it to the service 200 (and/or vice-versa) before content is shared between the device and the service and/or other services or devices which the service 200 interconnects. Similarly, users 105 could be required to enter a password or otherwise demonstrate their authorization to access the service 200 or an account associated therewith. External website and services 104 could similarly present credentials that demonstrate their authenticity.

FIG. 2B is an example of how a system 200 in accordance with some embodiments of the inventive body of work could be used to facilitate the secure, automated management of content. As shown in FIG. 2B, when the user connects his or her camcorder 102a to the system 200, video content from the camcorder can be automatically processed in accordance with user-defined rules 210. For example, the user might specify that video content from camcorder 102a should be posted on the user's video-sharing site 104c, but with settings that make it only accessible to the user's friends and family, and that another copy of the video content should be archived on a network storage service 104b. The user can set these rules once in advance, and on subsequent connections to the service 200, video content from the camcorder 102a can be processed in accordance therewith without further user interaction. In some embodiments (e.g., if the camcorder 102a has wireless communication capabilities, or is otherwise network connected), the device 102a could simply upload the video content at period intervals (or any time new video content was recorded) without any additional user interaction. If the user wanted to change how future video content was handled, he or she could simply log into his or her account with service 200 and change the rules associated with that type of content and/or that particular device or type of device.

FIG. 2C is an additional example of how a system 200 in accordance with some embodiments of the inventive body of work could be used to facilitate the secure, automated management of content. In the example shown in FIG. 2C, the user has set rules 212 relating to the processing of digital photographs from the user's digital camera 102g. In this example, the user has specified that when the camera 102g connects to the service 200, photographs should be automatically uploaded to an online archive service 104b, and posted to the user's online photo-sharing and social networking accounts 104a, 104d with settings that restrict access to authorized friends and family. In addition, the user may set a rule that indicates that the photographs should be automatically sent to the user's digital picture frame 102a if or when the picture frame connects to service 200. In preferred embodiments, each of the various communications shown in FIG. 2C can be performed in a secure fashion. For example, system 200 may require the user to log in with a password and/or otherwise demonstrate his or her identity before specifying the rules 212 and/or adding devices 102 or services 104 to the user's account. In addition, devices 102 and/or services 104 may be required to demonstrate their authenticity before sending and/or receiving content via service 200.

FIG. 2D is an additional example of how a system 200 in accordance with embodiments of the inventive body of work could be used to facilitate the secure, automated management of content. In the example shown in FIG. 2D, a user sends a request via the user's television 102e to service 200 requesting a certain video. In some embodiments, service 200 keeps a record of where content is stored (and/or stores metadata regarding content to enable searching based on keywords, time, author, etc.) and retrieves the content (in this example, from an online archive service 104b) and sends the content (e.g., via a download or stream) to the user's television 102g.

In preferred embodiments, the systems and methods described herein provide a service (sometimes referred to herein as a “hub” or “media hub”) that supports automated synchronization of user-generated content with user-specified device, services and/or recipients. For example, as shown in FIG. 2E, a user could set up his account with service 200 to recognize his wifi-enabled camera 250, and create a set of rules 252, 254, 256, 258 that govern what the service 200 should do with content that it receives from that source. For example, the user could specify that photos from the user's wifi-enabled camera 250 should be stored at a user-specified photo storage location (e.g., an online photo sharing and storage site 272) with access restricted to the user only, that low resolution versions should be made available on the user's homepage on a social networking site 274 with viewing privileges for friends only, that medium resolution versions should be made available via a photo-sharing and subscription service offered hub service 200 with viewing privileges for everyone, and that DRM-protected, watermarked high-resolution versions should be stored and made available to, e.g., subscribers, paying customers, and/or other specified individuals 284.

When the user takes a photo with this wifi-enabled camera 250, the picture is automatically uploaded to the service 200 or another content ingestion service. As shown in FIG. 2E, in some embodiments, the service 200 may authenticate the content source before accepting the content (260). For example, the user may have previously specified that the camera 250 is an element in the user's content network and indicated an authentication mechanism that could be used. The media hub service 200 recognizes and authenticates the camera 250 as a legitimate input device for this account, and the picture (or pictures) is uploaded from the camera 250 to the hub service 200. Once uploaded, the picture is processed according to the policy set for that input device. For example, the service 200 finds the rule or rules associated with the uploaded content, and automatically processes the content accordingly. In the example shown in FIG. 2E, the service 200 makes user-specified versions (e.g., different resolution versions) of the photo available, with user-specified access rules, to appropriate locations, such as the user's online accounts with popular photo, video, social networking, storage, and/or other services, user-specified groups, RSS feeds, and/or the like. Subsequent access to the content by other devices or users can be governed by these rules and/or similar policy and authentication methods. In some embodiments, the hub service 200 logs some or all of the actions taken.

Other content types and/or content from other devices may be pointed to different services and/or associated with different controls. For example, the user may choose to simply point some content to one or more of the user's content storage sites or services (e.g., a home-based server, an online file storage service, and/or the like).

In preferred embodiments, the hub service and its associated tools support users in their quest for intuitive and low maintenance management of their content across devices, groups, and services with assurance that their content will be accessible on the devices, in the places, by the people, and in the ways that the users intend.

In some embodiments, the media hub service may support a variety of access control paradigms, including, for example, access control rules applicable to single pieces or sets of content, user-specified groups with group-specific content access controls, persistent protection of content using DRM and/or other persistent protection mechanisms (e.g., encryption, authentication, etc.), and/or plug-ins to strong content identification mechanisms.

In some embodiments, the media hub service may support different e-commerce models for content acquisition, such as a traditional media storefront for selling user generated and/or other content (e.g., audio, video, text, software, etc.), purchase and subscription models, and/or advertisement-based content distribution models, to name just some examples.

One illustrative example embodiment of a media hub platform of the type described above is based on PHP: Hypertext Processor (PHP), with a collection of modules based on the Drupal Content Management Framework for content management, user management, theming, e-commerce, and the like. In order to support persistent DRM-protection of user generated content, this implementation uses a PHP backend with a DRM system such as that described in the '693 application and/or the 387 patent, which supports personalization, registration, agent notifications, content subscription license generation, as well as typical licenses bound directly to users, devices, or other principals. In this embodiment, the DRM support provides, among other things, simple server side packaging for license injection, and uses DRM-enabled browser plugins, enables group access to DRM-protected content via a subscription mechanism (e.g., members of a group are members of a group subscription and are able to access all content targeted to that subscription), and supports license suspension and revocation enforced by the hub service's manager. An example of why revocation or suspension might be useful is when users upload content as user-generated content that they do not in fact have the rights to upload. In such a case the hub service manager would have the option to revoke or suspend any DRM-based licenses associated with that content until such copyright issues are resolved.

In some embodiments, support is provided for creation and management of groups of contacts and group permissions and access controls for content, as well as support for an interface to watermarking and/or fingerprinting algorithms as desired by the user. In one embodiment, the system's components are cross-platform, and, e.g., a standard HTTP browser could be used for content download. In some embodiments, content can be moved to and from various services based on user-specified rules for distribution and access.

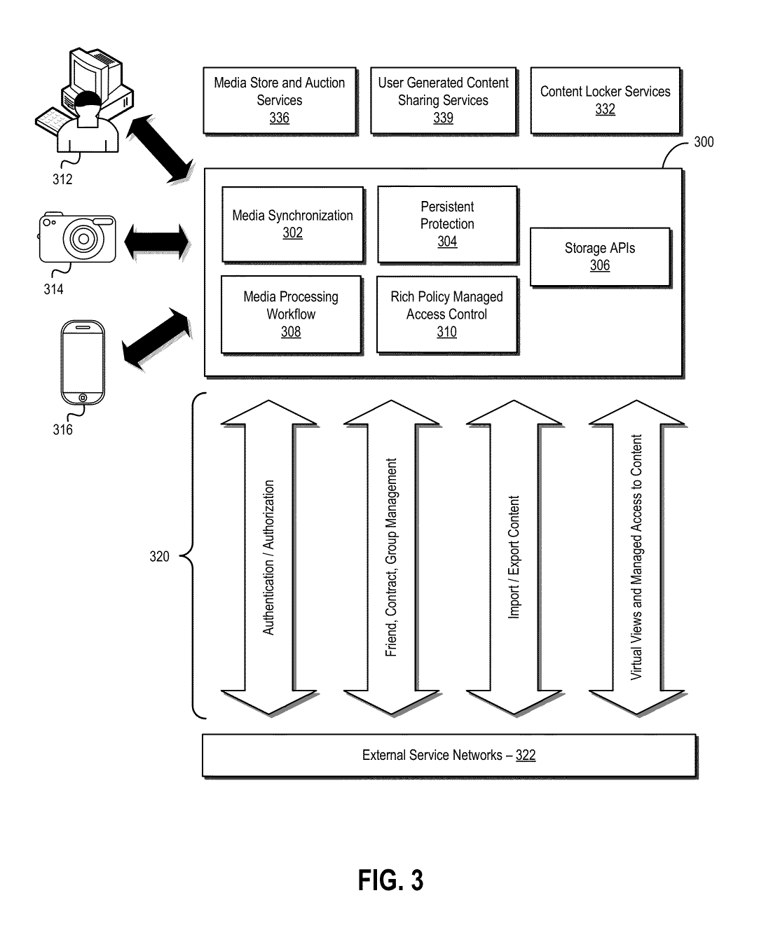

FIG. 3 depicts some elements and relationships in one illustrative embodiment of a media hub platform service 300. As shown in FIG. 3, in one embodiment service 300, includes some or all of software and/hardware 302 that facilitates synchronization of a user's content amongst the user's devices 314, 316, accounts, and services; security software and/or hardware 304 that can be used to protect and/or authenticate content, users, services, and/or the like (e.g., software and/or hardware for performing encryption, signature verification, watermarking, fingerprinting, key generation, key distribution, certification, and/or the like); application program interfaces (APIs) 306 for facilitating communication with the services and media associated with the service 300 by other software, services, and/or systems (e.g., APIs to facilitate storage of media, and/or the like); software and/or hardware 308 for processing media and routing it to appropriate destinations; and/or software and/or hardware 310 for exerting policy managed control of the user's content, accounts, and/or the like (e.g., DRM software such as that described in the '693 application could be used in some embodiments to facilitate the expression and enforcement of policies associated with a user's content).

In addition, as shown in FIG. 3, in some embodiments service 300 includes software and/or hardware 320 for interfacing and/or managing relationships with, and/or the control of, external services 322, such as Internet-based social networking sites, content-sharing sites, and/or the like. For example, as shown in FIG. 3, in some embodiments, service 300 could be configured to perform authentication and authorization checks on communications to and/or from external services 322 and/or users. In some embodiments, service 300 could also facilitate management and authorizations associated with a user's contacts, friends, families, or other groups associated with the user's accounts on external sites 322, facilitate the import and/or export of content between external services 322 and service 300, enable indirect virtual viewing and/or access to content associated with external services 322, and/or the like. As shown in FIG. 3, in some embodiments, service 300 may provide direct support for its own content sharing services 334, content storage services 322, media vending and/or other distribution services 336, and/or the like, in addition to (or instead of) facilitating the use of third-party services 322.

It will be appreciated that there are a number of ways to implement a hub service 300 such shown in FIG. 3. For example, the hub could be implemented by a combination of software and hardware running on an Internet web server, and the user could interact with the service using a web browser 312. In other embodiments, the software and/or hardware that comprise the hub service 300 could be distributed amongst local client software (e.g., “apps) that run on one or more of a user's local devices (e.g., the user's smartphone 316, tablet, PC, etc.), and some of the functionality could be implemented by server software and/or hardware at a location remote from the user, but capable of communicating therewith. In other embodiments, the service could be implemented entirely in software and/or hardware running on the user's local device(s) (e.g., a PC acting as a home network server, a smartphone, etc.). Thus, it will be appreciated that any suitable configuration could be used within the spirit of the present disclosure.

As previously indicated, in some embodiments, the server backend of a media hub service such as that shown in FIG. 3 can be implemented as a collection of PHP modules that run under Apache. In some embodiments, a small device implementation can be implemented in C++ and can provide support for access to content via Rendezvous-discovered REST services exported from the service 300. In one such embodiment, the service 300 allows users to create content groups and user groups, and to associate access policies with these groups in order to control access to content. In some embodiments, service 300 has a generic policy scheduler that schedules tasks to be processed by the policy engine 310.

The policies enforced by policy engine 310 may specify the actions to be taken on content, and can, in some embodiments, be defined by both users and system administrators. For example, a policy might specify rules relating to:
Content Delivery: E.g., a policy may specify that content should be copied or moved based on source and destination identifiers.
Content Transformation. E.g., a policy may specify that content should be transformed into different formats, including, for example, formats compatible or associated with different DRM systems.
Notification Delivery. E.g., a policy may specify that targeted alerts should be delivered to certain users or groups of users, e.g., upon the occurrence of specified events.

In addition to the above examples of content policy, in some embodiments support may be provided for more sophisticated delegation models in which users may delegate (e.g., for predetermined periods of time) to other users or groups the rights to administer policy on certain specified content groups.

In one embodiment, a service such as service 300 is implemented as a pluggable extensible framework that exists as a large scale network service (e.g., “in the cloud”). The service is capable of aggregating content from various sources (e.g., mobile networks, photo-sharing sites, online data archiving sites, social networking sites, video sharing sites, user devices, and/or the like) and transforming and presenting the content in various ways, including, for example, protecting it with DRM. The user's primary responsibility is to create policies that specify such things as content sources and destinations, transformations allowed, and user access rights. In another example embodiment, a more simple and portable version of the previous embodiment is provided that can more readily run on consumer electronic devices (e.g., smartphones, tablets, set top boxes, standard PCs, televisions, and/or the like). In one embodiment, multiple media hubs of the type shown in FIG. 3 can reside on a user's home network and can interact with each other.

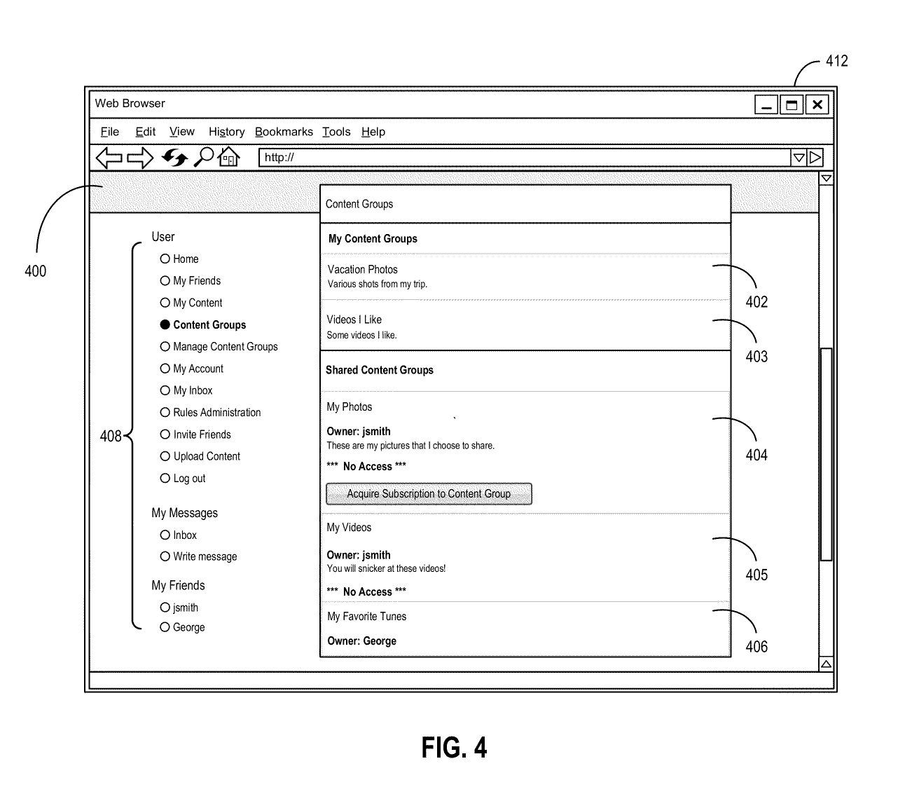

FIG. 4 illustrates an interface 400 for facilitating the creation of content groups in one embodiment of a service such as that shown in FIG. 3. As shown in FIG. 4, a basic front page is provided listing the user's own content groups (e.g., “Vacation Pictures” 402 and “Videos I Like” 403), as well as several shared content groups 404, 405, 406 (e.g., content groups created by the user's contacts). As shown in FIG. 4, the user might already have access to some of these shared groups, such as group 406, but may not have access to others (e.g., groups 404, 405), but may be given the option of acquiring access. Using a menu of options 408, users can manage their content, groups, contacts, and/or other aspects of their accounts. Although in the example shown in FIG. 4, interface 400 is presented within a web browser 412, it will be appreciated that in other embodiments, other configurations could be used. For example, in some embodiments, the interface could be part of an app running on a user's smartphone, tablet, PC, and/or the like in communication with one or more remote servers that perform some or all of the underlying functionality. Alternatively, the app itself may perform some or all of the underlying functionality.

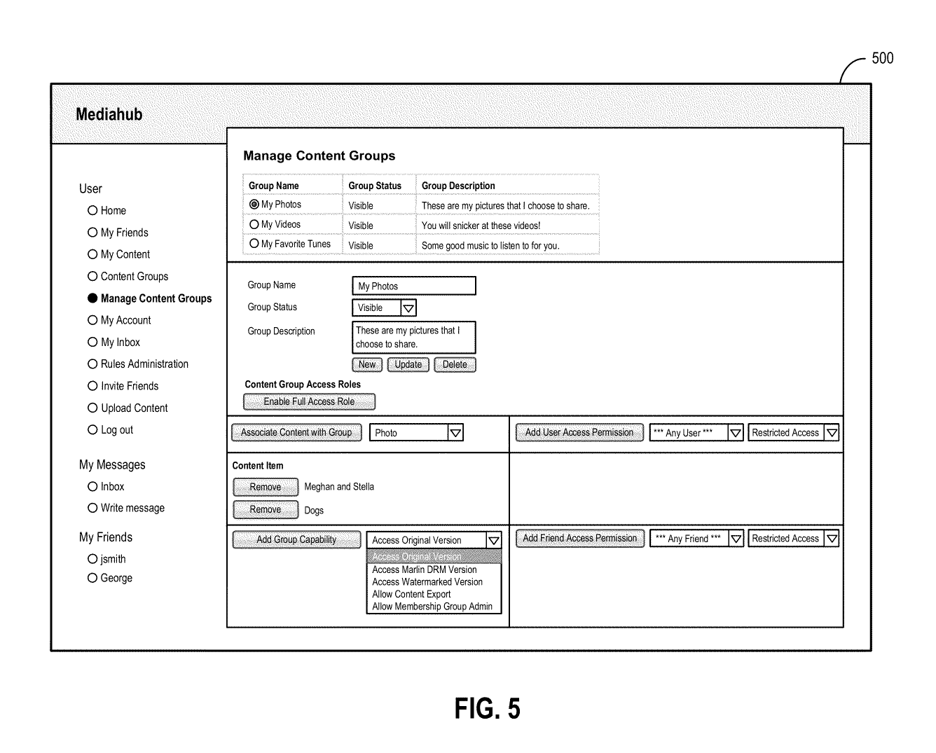

FIG. 5 shows another illustrative interface 500 for use with a service in accordance with some embodiments of the present disclosure. As shown in FIG. 5, interface 500 facilitates the specification and management of group members, group rights, and the content associated with a particular group. For example, a user can specify which of their groups are visible to third parties, the level of access (and/or the conditions associated with access) that is granted to third parties, the content items that are to form part of a particular content group, and/or the like.

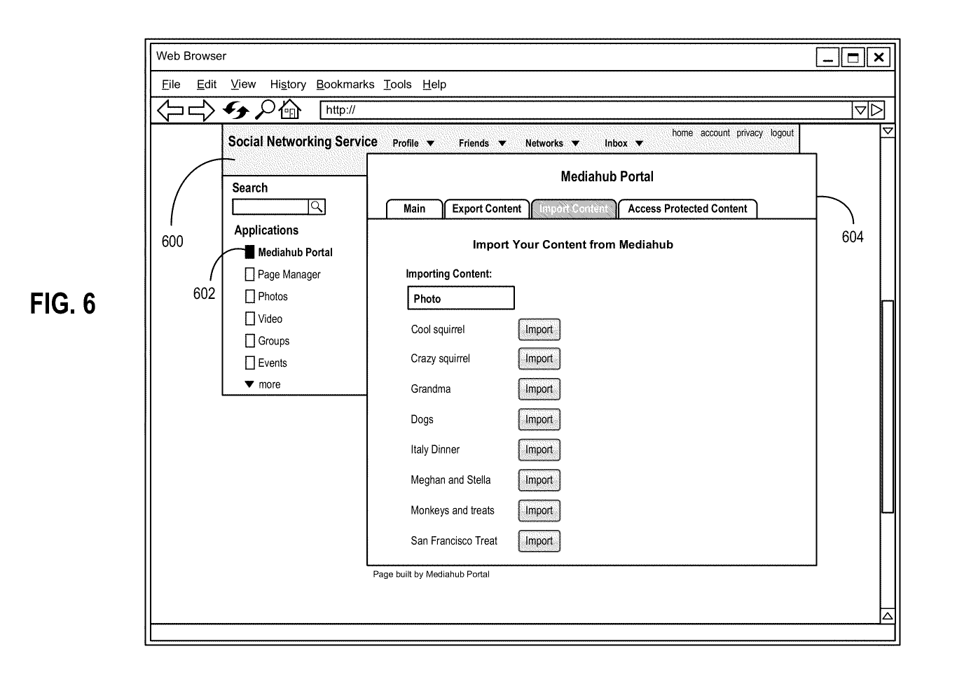

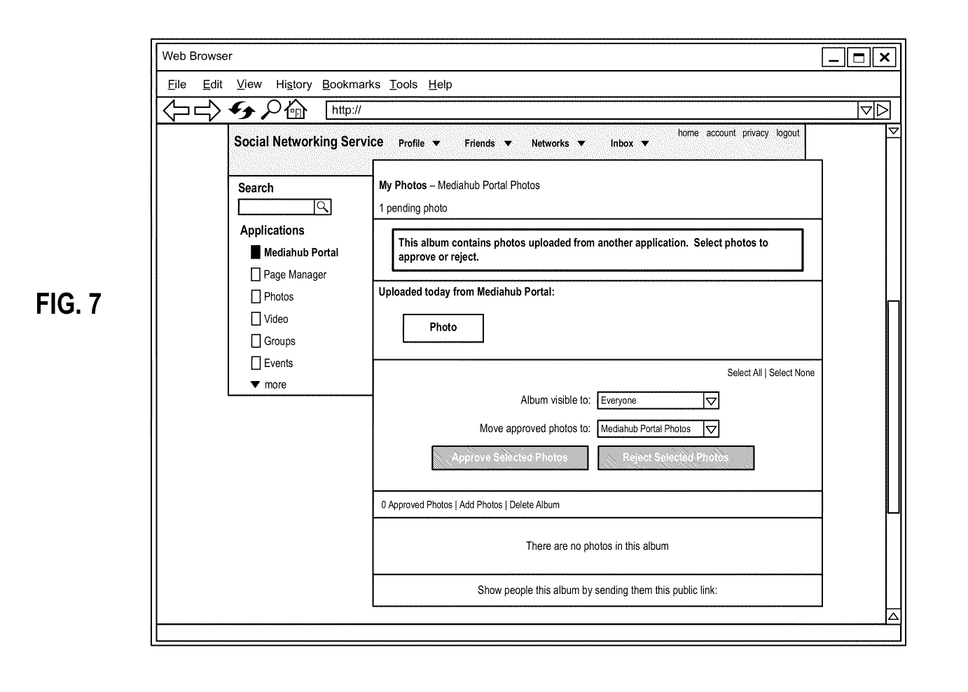

FIGS. 6-7 show examples of how a service in accordance with some embodiments of the present disclosure could be integrated with a social networking, content-sharing, and/or other service or site 600. As shown in FIG. 6, a menu item 602 could be added to the user's homepage on site 600 that provides an interface to a service such as service 300. When menu item 602 is selected, the user is presented with an interface 604 for managing content associated with his or her account with service 300. For example, as shown in FIG. 6, the user could be presented with options to add to or remove from their social networking homepage 600 content associated with their media hub service account. FIG. 7 shows an illustrative process for selecting a photo from the user's set of photographs associated with service 300 and importing it into the social networking site 600. In some embodiments, this process could be performed manually, while in other embodiments, this process could be automated so that the user can specify that certain photographs are to be automatically uploaded to the social networking site and/or other service.

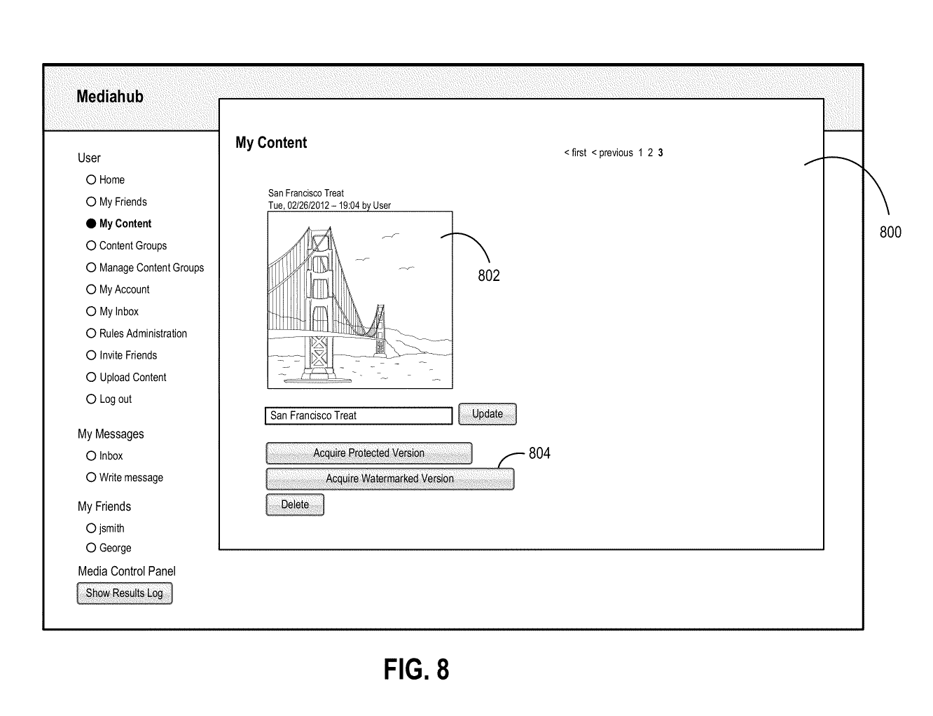

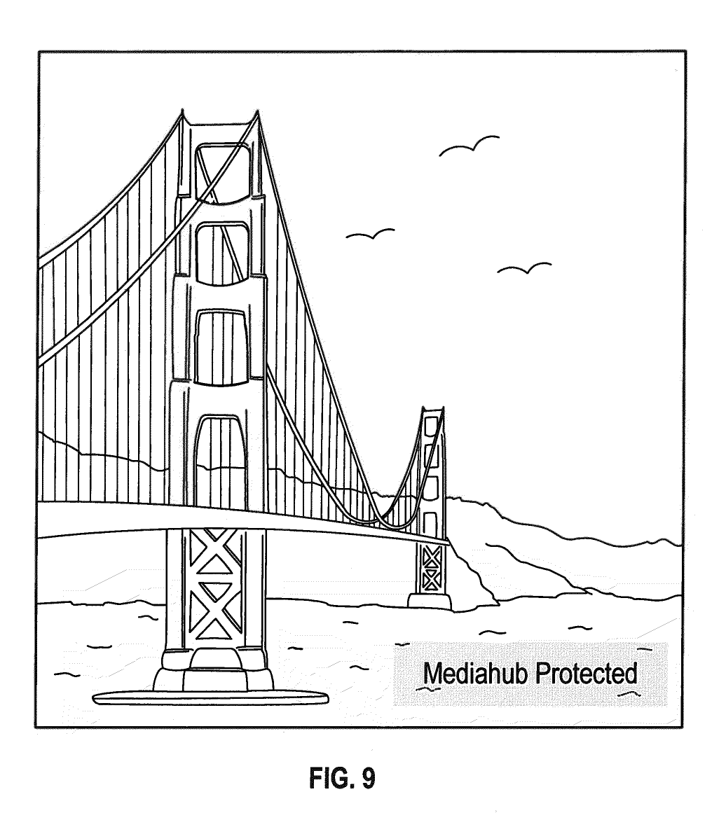

In some embodiments, service 300 provides support for watermarking. FIG. 8 shows an example interface 800 to a specific piece of content 802 in one illustrative embodiment, and shows an “Acquire Watermarked Version” button 804 under the photograph. As shown in FIG. 9, when a user opts to acquire a watermarked version of the content by selecting button 804, a watermarked version 906 of image 802 is provided. Although this example illustrates the use of a very simple form of watermarking (e.g. a visible mark), it will be appreciated that any suitable form of watermarking, fingerprinting, etc. could be used instead or in addition. It will also be appreciated that while, for the sake of illustration, FIGS. 8-9 illustrate interfaces for watermarking content, the illustrated interfaces and principles could be used for any other suitable purpose instead (e.g., acquiring DRM protected content, acquiring encrypted content, acquiring password protected content, and/or any other suitable purpose).

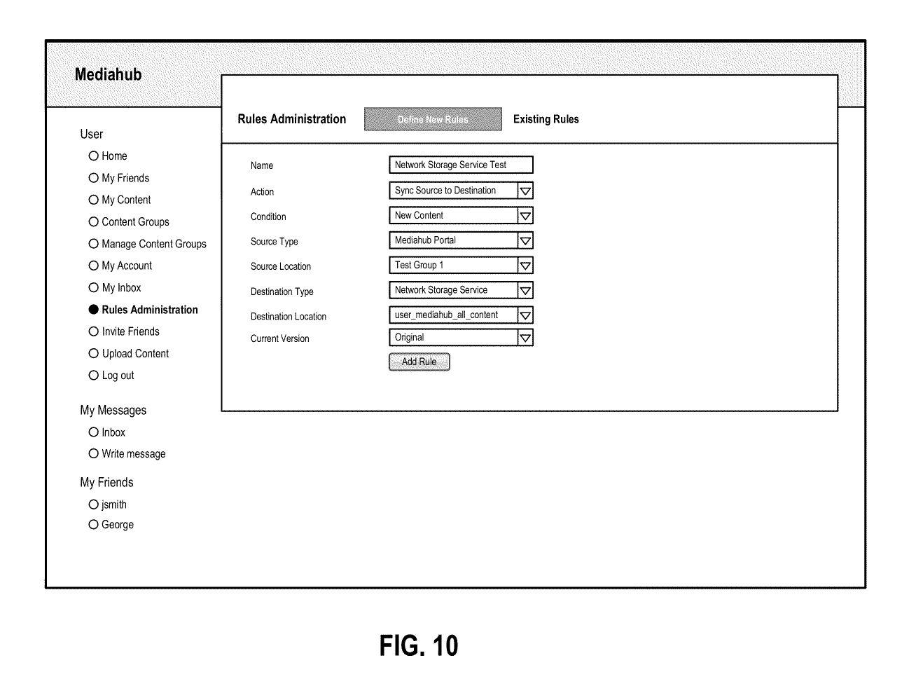

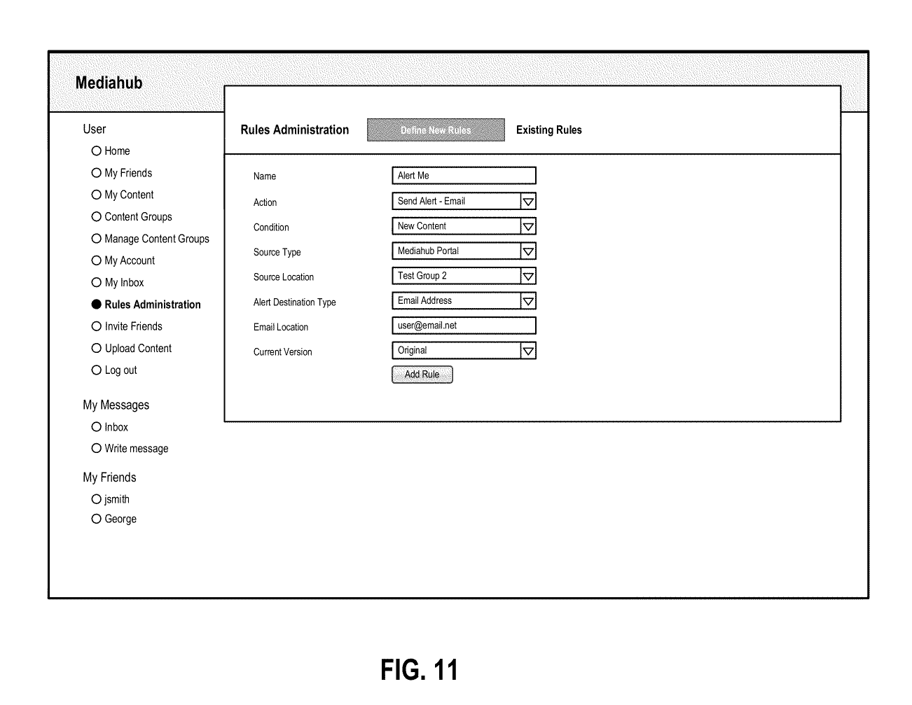

As shown in FIGS. 10-11, in some embodiments a media hub service as disclosed herein exposes aspects of an underlying DRM system (e.g., of the type described in the '693 application or any other suitable system) to allow users to create certain types of automation and/or other rules for managing their content. For example, as shown in FIGS. 10-11, a user might create a policy specifying that when new content arrives for a given content group in a system such as that illustrated in FIG. 3, two rules will be applied: one (shown being specified in FIG. 10 via a menu that allows the user to select options from a drop down menu associated with each data box) that synchronizes content to the user's external, online storage account for archival purposes, and another, shown being specified in FIG. 11, that sends an email alert to a designated user. Alternatively, or in addition, the user might create a rule that synchronizes all content in a given folder on the user's social network page to a specified folder managed by system 300. It will be appreciated that these are merely two examples of rules that could be specified in some embodiments, and that in other embodiments, other rules could be specified.

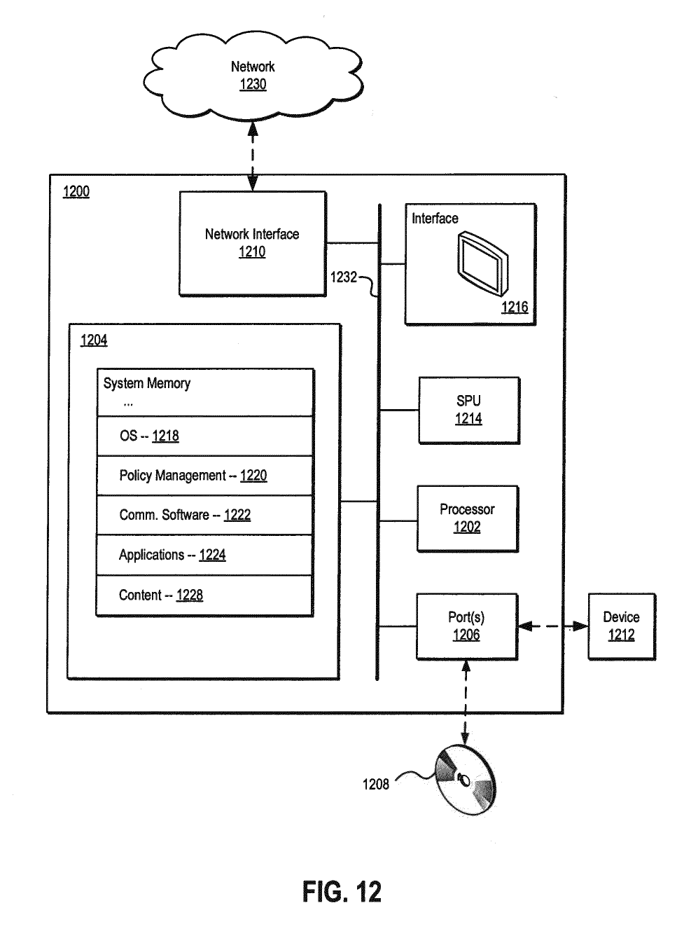

FIG. 12 shows an illustrative computer system 1200 that could be used to implement embodiments of the systems and methods disclosed herein. The exemplary system 1200 may comprise a general purpose computing device such as a personal computer or a network server (e.g., associated with a user or a service), or a specialized computing device such as a cellular telephone (e.g., a smartphone), a tablet, a personal digital assistant, or the like. As illustrated in FIG. 12, the system 1200 may include a processing unit 1202; system memory 1204, which may include high speed random access memory (“RAM”), non-volatile memory (“ROM”), and/or one or more bulk non-volatile computer-readable storage mediums (e.g., a hard disk, flash memory, etc.) for storing programs and other data for use and execution by the processing unit 1202; one or more ports 1206 for interfacing with associated devices (e.g., cameras, mobile phones, etc.) 1212 and/or with removable memory 1208 that may include one or more diskettes, optical storage mediums, memory cards, flash memory, thumb drives, USB dongles, compact discs, DVDs, and/or other computer-readable storage mediums; a network interface 1210 for communicating with other systems via one or more networks 1230 such as the Internet, a local area network (LAN), a cellular network, and/or the like using one or more communication technologies; a user interface 1216 that may include a display and/or one or more input/output devices such as, for example, a touchscreen, a keyboard, a mouse, a track pad, and the like; and one or more busses 1232 for communicatively coupling the elements of the system 1200.

In some embodiments, the system 1200 may, alternatively or in addition, include a secure processing unit (“SPU”) 1214 that is protected from tampering by a user of system 1200 or other entities by utilizing secure physical and/or virtual security techniques. An SPU 1214 can help enhance the security of sensitive operations such as trusted credential and/or key management, privacy and policy management, and other aspects of the systems and methods disclosed herein. In certain embodiments, the SPU 1214 may operate in a logically secure processing domain and be configured to protect and operate on secret information. In some embodiments, the SPU 1214 may include internal memory storing keys, certificates, unique identifiers, and/or executable instructions or programs configured to enable to the SPU 1214 to perform secure operations, as described herein. In some embodiments an SPU such as described in commonly-assigned U.S. Pat. No. 7,430,585 and/or U.S. Pat. No. 5,892,900 can be used.

The operation of the system 1200 may be generally controlled by a processing unit 1202 and/or a SPU 1214 operating by executing software instructions and programs stored in the system memory 1204 (and/or other computer-readable media, such as removable memory 1208). The system memory 1204 may store a variety of executable programs or modules for controlling the operation of the system 1200. For example, the system memory 1204 may include an operating system (“OS”) 1218 that may manage and coordinate, at least in part, system hardware resources and provide for common services for execution of various applications, and a policy management and rules enforcement system (e.g., a DRM engine such as that described in the '693 application) 1220 for implementing trust and privacy management functionality. The system memory 1204 may further include, without limitation, communication software 1222 configured to enable in part communication within and by the system 1200, applications 1224 (e.g., media applications, an embodiment of the hub service 300, and/or an application that interfaces therewith), data, and/or content 1228.

The systems and methods disclosed herein are not inherently related to any particular computer, electronic control unit, or other apparatus and may be implemented by any suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a disk drive, compact disk, digital-video disk, a magnetic tape, a magnetic disk, flash memory, integrated circuits, or any other non-transitory digital storage and/or processing apparatus or memory device.

Although the foregoing has been described in some detail for purposes of clarity, it will be apparent that certain changes and modifications may be made without departing from the principles thereof. For example, the systems and methods described herein can, for example, be used in connection with the DRM technology described in the '693 application, and/or the DRM or service orchestration technology described in the '387 patent, and in other contexts as well. It will be appreciated that these systems and methods are novel, as are many of the components, systems, and methods employed therein. It should be noted that there are many alternative ways of implementing both the processes and apparatuses described herein. Accordingly, the present embodiments are to be considered as illustrative and not restrictive, and the invention is not to be limited to the details given herein, but may be modified within the scope and equivalents of the appended claims.

What is claimed is:

1. A method for managing electronic content using a computer system, the method comprising:
authenticating a first device in communication with the computer system;
obtaining one or more pieces of electronic content from the first device; and
automatically sending the one or more pieces of electronic content, or copies thereof, to one or more specified destinations external to the computer system in accordance with one or more user-specified policies.

2. The method of claim 1, further comprising:
watermarking at least one of the pieces of electronic content, or a copy thereof, before routing the at least one piece of electronic content, or copy thereof, to at least one of the one or more specified destinations.

3. The method of claim 1, wherein at least one of the one or more pieces of electronic content comprises a digital photograph, the method further comprising:
reducing the resolution of the at least one piece of electronic content, or a copy thereof, before routing the at least one piece of electronic content, or copy thereof, to at least one of the one or more specified destinations.

4. A method of configuring and operating an automated electronic media distribution service, the method comprising: identifying to the media distribution service, one or more authorized sources of electronic content;
specifying a category of electronic content;
identifying one or more users authorized to access content within the category of electronic content;
identifying one or more destinations for content within the category of electronic content;
identifying one or more policies to govern access to electronic content within the category;
authenticating a first device as one of the one or more authorized sources of electronic content;
obtaining electronic content from the first device;
determining that the electronic content falls within the specified category of electronic content;
securely associating control information with the electronic content in accordance with the one or more policies;
automatically sending the electronic content, or a copy thereof, to the one or more users.

5. The method of claim 4, wherein the category of electronic content comprises all content obtained from a specified device.

6. The method of claim 5, wherein the specified device comprises a digital camera.

7. The method of claim 6, wherein the category of electronic content comprises all content having a specified file type.

8. The method of claim 7, further comprising, specifying one or more conditions associated with access to the category of electronic content by the one or more authorized users.

9. The method of claim 4, wherein the one or more authorized sources of electronic content comprise one or more specified electronic devices.

10. The method of claim 4, wherein the one or more authorized sources of electronic content comprise one or more specified Internet web sites.

11. The method of claim 4, wherein the one or more destinations of electronic content comprise one or more specified Internet web sites.
